(19) United States
(12) Patent Application Publication
(10) Pub. No.: US 2024/0265245 A1
(43) Pub. Date: Aug. 8, 2024

(54) ANOMALY DATA DETECTION DEVICE AND OPERATION METHOD OF THE SAME

(71) Applicant: ELECTRONICS AND TELECOMMUNICATIONS RESEARCH INSTITUTE, Daejeon (KR)

(72) Inventors: Tae Wook KANG, Daejeon (KR); Sung Eun KIM, Daejeon (KR); Kyung Jin BYUN, Daejeon (KR); Kwang Il OH, Daejeon (KR); Jae-Jin LEE, Daejeon (KR)

(21) Appl. No.: 18/235,919

(22) Filed: Aug. 21, 2023

(30) Foreign Application Priority Data
Feb. 3, 2023 (KR) 10-2023-0014612

(51) Int. Cl. G06N 3/049; G06N 3/063

(52) U.S. Cl. CPC G06N 3/049; G06N 3/063

(57) ABSTRACT

Disclosed is an anomaly data detection device, which includes a sampler that generates session data including first to m-th sample data based on input data input during a first time interval, a spike signal generator that generates first to m-th spike signals respectively corresponding to the first to m-th sample data based on the session data, a spike neural network that detects whether an output spike fires in at least one output neuron from among output neurons based on the first to m-th spike signals and synaptic weights of each of the output neurons, and a detection circuit that generates a detection signal based on the number of output neurons firing the output spike, and each of the first to m-th spike signals is generated by converting feature information of the corresponding first to m-th sample data into a spike rate code.

### CROSS-REFERENCE TO RELATED APPLICATIONS

This application claims priority under 35 U.S.C. § 119 to Korean Patent Application No. 10-2023-0014612 filed on Feb. 3, 2023, in the Korean Intellectual Property Office, the disclosures of which are incorporated by reference herein in their entireties.

### BACKGROUND

### 1. Field of the Invention

Embodiments of the present disclosure described herein relate to an anomaly data input detection, and more particularly, relate to an anomaly data input detection device using an inference result of a spiking neural network (SNN) in which learning continuously evolves with respect to input data, and an operation method thereof.

### 2. Description of Related Art

In a system, it may be necessary to continuously observe whether anomaly data is input, such as processing anomaly traffic in a computer network, detecting an anomaly object in an airborne radar, or anomaly signs in biosignals. In such case, a low-power operation for processing continuously input data and a technology capable of quickly detecting anomaly data generation while adapting to changes in a normal range of input data may be required in the system.

### SUMMARY

Embodiments of the present disclosure provide an anomaly data detection device and an operating method thereof capable of quickly detecting anomaly data input by performing evolutionary learning on data changes in a normal range.

According to an embodiment of the present disclosure, an anomaly data detection device includes a sampler that generates session data including first to m-th sample data based on input data input during a first time interval, a spike signal generator that generates first to m-th spike signals respectively corresponding to the first to m-th sample data based on the session data, a spike neural network that detects whether an output spike fires in at least one output neuron from among a plurality of output neurons based on the first to m-th spike signals and synaptic weights of each of the plurality of output neurons, and a detection circuit that generates a detection signal based on the number of output neurons firing the output spike, and each of the first to m-th spike signals is generated by converting feature information of the corresponding first to m-th sample data into a spike rate code.

According to an embodiment, the feature information may include a size value and a change value of each of the first to m-th sample data.

According to an embodiment, the spike neural network may determine the at least one output neuron to detect whether the output spike fires based on a first correlation between a random distribution of the first to m-th spike signals and a random distribution of the synaptic weights connected to each of the plurality of output neurons.

According to an embodiment, the spike neural network may perform a first operation on the synaptic weights connected to the at least one output neuron and the first to m-th spike signals, the spike neural network may perform a second operation on a result of the first operation and the at least one output neuron, and the spike neural network may detect whether the output spike is fired in the at least one output neuron when a result of the second operation exceeds a threshold value.

According to an embodiment, the spike neural network may increase the synaptic weights connected to the at least one output neuron when the output spike is fired in the at least one output neuron.

According to an embodiment, the output neurons may include the at least one output neuron and remaining output neurons, and when the output spike is fired in the at least one output neuron, the spike neural network may maintain synaptic weights connected to each of the remaining output neurons.

According to an embodiment, the sampler may generate first session data based on first input data input during the first time interval and may generate second session data based on second input data input during the first time interval, and the spike neural network may detect whether the output spike fires in at least one first output neuron with respect to the first session data or the second session data based on a second correlation between the first session data and the second session data.

According to an embodiment, when the output spike is fired in the at least one first output neuron based on the first session data, the spike neural network may increase synaptic weights connected to the at least one first output neuron to a first value, and when the output spike is fired in the at least one first output neuron based on the second session data, the spike neural network may update the synaptic weights connected to the at least one first output neuron from the first value to a second value.

According to an embodiment, the sampler may generate third session data based on third input data input during the first time interval, the spike neural network may detect whether the output spike fires in at least one second output neuron with respect to the third session data based on a third correlation between the first session data or the second session data and the third session data, and when the output spike is fired in the at least one second output neuron based on the third session data, the spike neural network may increase synaptic weights connected to the at least one second output neuron and may maintain synaptic weights connected to the at least one first output neuron.

According to an embodiment, the sampler may generate fourth session data based on fourth input data input during a second time interval after the first time interval, the spike neural network may detect whether the output spike is fired in the at least one output neuron with respect to the fourth session data, and the detection circuit may generate a first detection signal based on an absence of an output neuron firing the output spike above a first value.

According to an embodiment, the detection circuit may compare the number of the output neurons with a second value based on a presence of the output neuron firing the output spike above the first value, and the detection circuit may generate the first detection signal based on that the number of the output neurons exceeds the second value.

According to an embodiment, the detection circuit may generate a second detection signal based on that the number of the output neurons is less than or equal to the second value.

According to an embodiment of the present disclosure, a method of operating an anomaly data detection device including a sampler, a spike signal generator, a spike neural network, and a detection circuit, includes generating, by the sampler, session data including first to m-th sample data based on input data input during a first time interval, generating, by the spike signal generator, first to m-th spike signals respectively corresponding to the first to m-th sample data based on the session data, detecting, by the spike neural network, whether an output spike fires in at least one output neuron from among a plurality of output neurons based on the first to m-th spike signals and synaptic weights of each of the plurality of output neurons, and generating, by the detection circuit, a detection signal based on the number of output neurons firing the output spike, and each of the first to m-th spike signals is generated by converting feature information of the corresponding first to m-th sample data into a spike rate code.

According to an embodiment, the detecting of whether the output spike fires may include determining the at least one output neuron to detect whether the output spike fires based on a first correlation between a random distribution of the first to m-th spike signals and a random distribution of the synaptic weights connected to each of the plurality of output neurons.

According to an embodiment, the detecting of whether the output spike fires may include performing, by the spike neural network, a first operation on the synaptic weights connected to the at least one output neuron and the first to m-th spike signals, performing, by the spike neural network, a second operation on a result of the first operation and the at least one output neuron, and detecting, by the spike neural network, whether the output spike is fired in the at least one output neuron when a result of the second operation exceeds a threshold value.

According to an embodiment, the spike neural network may increase the synaptic weights connected to the at least one output neuron when the output spike is fired in the at least one output neuron.

According to an embodiment, the output neurons may include the at least one output neuron and remaining output neurons, and when the output spike is fired in the at least one output neuron, the spike neural network may maintain synaptic weights connected to each of the remaining output neurons.

According to an embodiment, the method of operating an anomaly data detection device may further include generating, by the sampler, second session data based on second input data input during a second time interval after the first time interval, and detecting, by the spike neural network, whether the output spike is fired in the at least one output neuron with respect to the second session data, and the generating of the detection signal may include generating, by the detection circuit, a first detection signal based on an absence of an output neuron firing the output spike above a first value.

According to an embodiment, the generating of the detection signal may further include comparing, by the detection circuit, the number of the output neurons with a second value based on a presence of the output neuron firing the output spike above the first value, and generating, by the detection circuit, the first detection signal based on that the number of the output neurons exceeds the second value.

According to an embodiment, the generating of the detection signal may further include generating, by the detection circuit, a second detection signal based on that the number of the output neurons is less than or equal to the second value.

### BRIEF DESCRIPTION OF THE DRAWINGS

The above and other objects and features of the present disclosure will become apparent by describing in detail embodiments thereof with reference to the accompanying drawings.

FIG. 1 is a diagram illustrating an anomaly data detection device, according to an embodiment of the present disclosure.

FIG. 2 is a diagram illustrating an embodiment in which a spike signal generator generates input spike signals based on sample data.

FIG. 3 is a diagram illustrating an embodiment in which a spike neural network (SNN) determines output neurons based on input spike signals.

FIG. 4 is a diagram illustrating an embodiment in which a spike neural network (SNN) determines whether an output spike of a first output neuron fires.

FIG. 5A is a diagram illustrating a first embodiment describing the number of output spike firings in each of output neurons.

FIG. 5B is a diagram illustrating a second embodiment describing the number of output spike firings in each of the output neurons.

FIG. 5C is a diagram illustrating a third embodiment describing the number of output spike firings in each of the output neurons.

FIG. 6 is a flowchart illustrating an operation method of an anomaly data detection device during a first time interval, according to an embodiment of the present disclosure.

FIG. 7 is a flowchart illustrating an operation method of an anomaly data detection device during a second time interval after a first time interval, according to an embodiment of the present disclosure.

### DETAILED DESCRIPTION

Hereinafter, embodiments of the present disclosure will be described clearly and in detail such that those skilled in the art may easily carry out the present disclosure. An artificial neural network (ANN) may emulate neurons and synapses included in the human brain to implement human thinking, inferring, and learning processes in an electronic device. The artificial neural network (ANN) may be applied to electronic devices as a technology for detecting anomaly data occurrence. The artificial neural network (ANN) may provide effective problem-solving capabilities for information by changing synaptic coupling strength through learning. The artificial neural network (ANN) may be applied to various fields such as risk recognition, security and surveillance, autonomous driving, smart management, and Internet of Things.

However, perceptron-based artificial neural networks (ANNs) or convolution-based artificial neural networks (ANNs) applied to electronic devices may change the coupling strength of all synapses connected to an output neuron layer through learning. In this case, it may be difficult to quickly process input data. Therefore, a new artificial neural network (ANN) capable of quickly detecting anomaly data occurrence may be required.

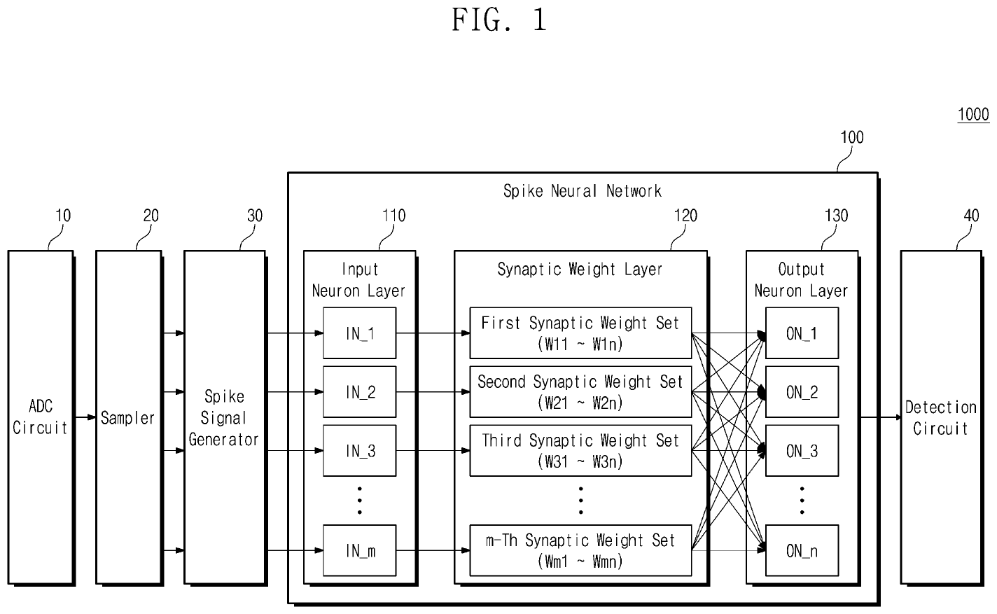

FIG. 1 is a diagram illustrating an anomaly data detection device 1000 according to an embodiment of the present disclosure. Referring to FIG. 1, the anomaly data detection device 1000 may include an analog-to-digital conversion (ADC) circuit 10, a sampler 20, a spike signal generator 30, a spike neural network (SNN) 100, and a detection circuit 40.

The anomaly data detection device 1000 may be at least one of a mobile device such as a smart phone, a smart watch, and a tablet personal computer (PC), or a smart device such as a laptop computer and a computer. However, it is not limited thereto, and the anomaly data detection device 1000 may include all electronic devices to which the spike neural network (SNN) 100 may be applied.

The ADC circuit 10 may receive analog type input data from the outside. The ADC circuit 10 may convert analog input data into discretized input data by performing an analog-to-digital conversion operation.

The sampler 20 may periodically receive the discretized input data from the ADC circuit 10. The sampler 20 may generate first to m-th sample data by sampling the discretized input data whenever discretized input data is received. Here, for example, ‘m’ is a natural number greater than or equal to 2.

The spike signal generator 30 may receive first to m-th sample data from the sampler 20. The spike signal generator 30 may generate first to m-th input spike signals based on the first to m-th sample data. Input spikes included in each of the first to m-th input spike signals may include feature information of corresponding the first to m-th sample data.

The spike signal generator 30 may encode the feature information of the first to m-th sample data corresponding to the input spikes included in each of the first to m-th input spike signals. The spike signal generator 30 may use rate coding as an encoding method. However, the encoding method of the spike signal generator 30 is not limited thereto.

The feature information of the first to m-th sample data may include a size value or a change value of each of the first to m-th sample data. For example, the number of spikes of the input spike signal may increase as the magnitude value of the sample data increases. As the change value of the sample data increases, the number of spikes of the input spike signal may increase.

Spike intervals of each of the first to m-th input spike signals may have a random Poisson distribution. However, the spike intervals of the input spike signals are not limited thereto.

The spike signal generator 30 may continuously receive the first to m-th sample data based on the samplings of the sampler 20, and input the first to m-th spike signals generated in response thereto are defined as input data (hereinafter referred to as session data) associated with one session. For example, the spike signal generator 30 may generate first to n-th session data with respect to ‘n’ sessions. Here, for example, ‘n’ is a natural number equal to or greater than ‘m’. The number ‘n’ may correspond to the number of output neurons ON_1 to ON_n of an output neuron layer 130 included in the spike neural network (SNN) 100, which will be described later.

The spike neural network (SNN) 100 may include an input neuron layer 110, a synaptic weight layer 120, and the output neuron layer 130.

In the spike neural network (SNN) 100, spike signals having a pulse shape that toggles in a short time, rather than signals of a specific level, may be transferred from the input neuron layer 110 to the output neuron layer 130.

The spike neural network (SNN) 100 may use a spike-timing-dependent plasticity (STDP) learning algorithm. The STDP learning algorithm may be a learning algorithm based on a difference between an output time of input spike signals in the input neuron layer 100 and an output time of output spike signals in the output neuron layer 130.

The input neuron layer 100 may include a plurality of input neurons IN_1 to IN_m. Each of the plurality of input neurons IN_1 to IN_m may receive the corresponding first to m-th input spike signals from the spike signal generator 30. The plurality of input neurons IN_1 to IN_m may output the first to m-th input spike signals to the synaptic weight layer 120.

The synaptic weight layer 120 may include a first synaptic weight set to an m-th synaptic weight set. Each of the synaptic weight sets may include a plurality of synaptic weights.

For example, the first synaptic weight set may include a plurality of first synaptic weights W11 to Win. The second synaptic weight set may include a plurality of second synaptic weights W21 to W2n. The third synaptic weight set may include a plurality of third synaptic weights W31 to W3n. In this way, the m-th synaptic weight set may include a plurality of m-th synaptic weights Wm1 to Wmn.

The synaptic weight layer 120 may perform a first operation based on the first to m-th input spike signals and the synaptic weights. The first operation may include a multiplication operation between the first to m-th input spike signals and corresponding synaptic weights.

The output neuron layer 130 may include the plurality of output neurons ON_1 to ON_n. The number of the plurality of output neurons ON_1 to ON_n may be the same as or different from the number of the plurality of input neurons IN_1 to IN_m.

Each of the plurality of output neurons ON_1 to ON_n may be connected to synaptic weights included in the synaptic weight layer 120. For example, the first output neuron ON_1 may be connected to the synaptic weights W11, W21, and W31 to Wm1. The second output neuron ON_2 may be connected to the synaptic weights W12, W22, and W32 to Wm2.

The third output neuron ON_3 may be connected to the synaptic weights W13, W23, and W33 to Wm3. In this way, the n-th output neuron ON_n may be connected to the synaptic weights W1n, W2n, and W3n to Wmn.

The synaptic weights used in the first operation may be at least one group of synaptic weights respectively connected to the plurality of output neurons ON_1 to ON_n. A detailed description of a configuration for determining at least one group used in the first operation will be described later.

The output neuron layer 130 may receive a first operation result from the synaptic weight layer 120. The output neuron layer 130 may perform a second calculation operation of summing the first operation result. The output neuron layer 130 may accumulate the second operation result and may store it as a membrane potential value. The output neuron layer 130 may fire an output spike based on that the membrane potential value exceeds a membrane potential threshold value.

The spike neural network (SNN) 100 may train the synaptic weights of the synaptic weight layer 120 based on firing output spikes. In this case, synaptic weights connected to output neurons firing output spikes may be trained to increase in value. The synaptic weights connected to output neurons that do not fire output spikes may maintain their values.

The detection circuit 40 may receive output spike signals from the output neuron layer 130. The detection circuit 40 may generate a detection signal based on the number of spikes of each of the output spike signals and the number of output neurons firing a specific number or more of output spikes. The anomaly data detection device 1000 may detect whether anomaly data is input based on the detection signal. A detailed description of the configuration of the detection signal will be described later.

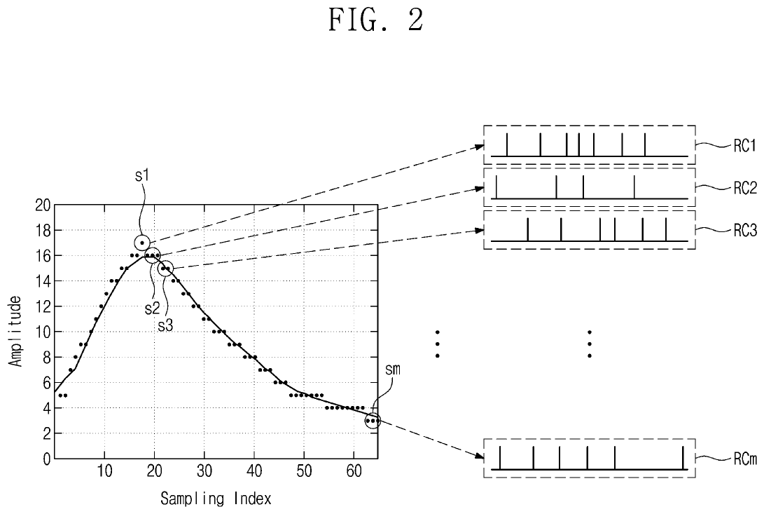

FIG. 2 is a diagram illustrating an embodiment in which a spike signal generator generates input spike signals based on sample data. By way of example, in FIG. 2, session data with respect to one session will be described. A sampling index may mean the number of samplings, and an amplitude may mean the size of data.

The sampling index may correspond to the number of the plurality of input neurons. The amplitude may correspond to the number of spikes of the input spike signal.

Referring to FIGS. 1 and 2, the session data may include first to m-th rate coded signals RC1 to RCm. Here, the first to m-th rate coded signals RC1 to RCm may correspond to the first to m-th input spike signals, respectively.

For example, the first rate coded signal RC1 may be a signal obtained by encoding feature information of first sample data s1. The second rate coded signal RC2 may be a signal obtained by encoding feature information of second sample data s2. The third rate coded signal RC3 may be a signal obtained by encoding feature information of third sample data s3. In this way, the m-th rate coded signal RCm may be a signal obtained by encoding feature information of m-th sample data sm.

Illustratively, in FIG. 2, the first sample data s1 may have a larger data size value than the second to m-th sample data s2 to sm. Alternatively, the first sample data s1 may have a larger data change value than the second to m-th sample data s2 to sm. Accordingly, although not all of the number of spikes are illustrated, the number of spikes of the first rate coded signal RC1 may be greater than the number of spikes of each of the second to m-th rate coded signals RC2 to RCm.

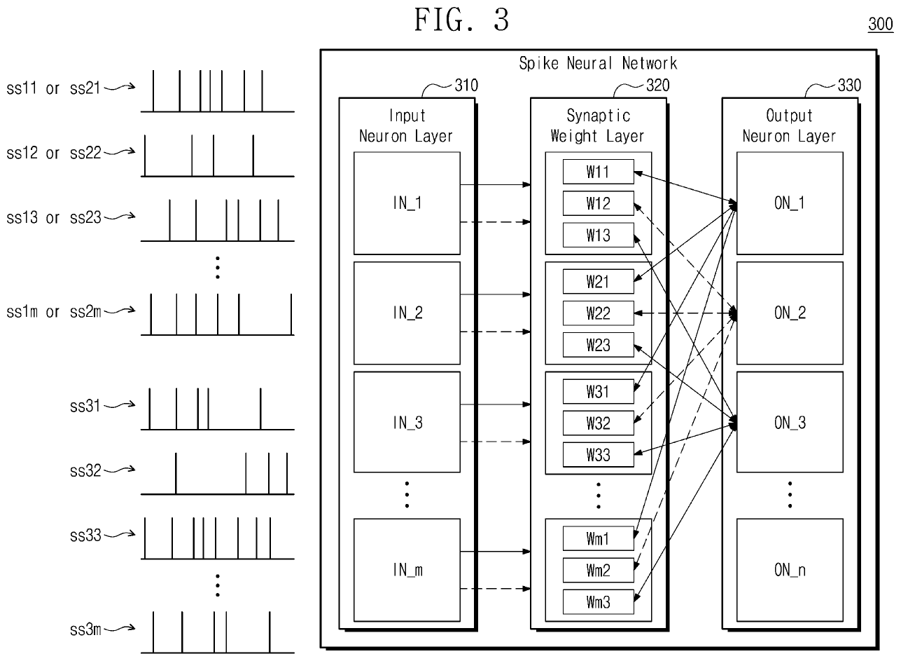

FIG. 3 is a diagram illustrating an embodiment in which a spike neural network (SNN) determines output neurons based on input spike signals. Illustratively, an input neuron layer 310, a synaptic weight layer 320, and an output neuron layer 330 included in a spike neural network (SNN) 300 of FIG. 3 correspond to the input neuron layer 110, the synaptic weight layer 120, and the output neuron layer 130 included in the spike neural network (SNN) 100 of FIG. 1, respectively. Therefore, additional descriptions of similar components and similar operations will be omitted to avoid redundancy.

Referring to FIGS. 1 and 3, the plurality of input neurons IN_1 to IN_m included in the input neuron layer 310 may receive spike signals whenever data is input. The data may include first to n-th session data. In FIG. 3, the spike neural network (SNN) 300 is illustrated as receiving the first to third session data.

Each of the first to m-th input neurons IN_1 to IN_m is connected to the plurality of output neurons ON_1 to ON_n included in the output neuron layer 330 through synaptic weights included in the synaptic weight layer 320. Before session data is input, the synaptic weights connected to each of the plurality of output neurons ON_1 to ON_n may have a random distribution characteristic.

The spike neural network (SNN) 300 may determine at least one output neuron to determine whether output spike is fired based on the correlation between a random distribution characteristic of first to m-th input spike signals ss11 to ss1m included in the first session data and a random distribution characteristic of synaptic weights. Before the first to m-th input spike signals ss11 to ss1m are input to the spike neural network (SNN) 300, synaptic weights may have random values.

Illustratively, in FIG. 3, the random distribution characteristic of the first to m-th input spike signals ss11 to ss1m has a high correlation with the random distribution characteristic of the synaptic weights W11, W21, and W31 to Wm1 connected to the first output neuron ON_1, or with the random distribution characteristic of the synaptic weights W13, W23, and W33 to Wm3 connected to the third output neuron ON_3.

The random distribution characteristic of the first to m-th input spike signals ss21 to ss2m included in the second session data has a high correlation with the random distribution characteristic of synaptic weights W11, W21, and W31 to Wm1 connected to the first output neuron ON_1, or with the random distribution characteristic of the synaptic weights W13, W23, W33 to Wm3 connected to the third output neuron ON_3.

In detail, the random distribution characteristic of the first to m-th input spike signals ss11 to ss1m may have a high correlation with the random distribution characteristic of the first to m-th input spike signals ss21 to ss2m.

In this case, the high correlation of the random distribution characteristics may mean that the high correlation of the number of input spikes input to each input neuron.

For example, when the number of input neurons is 3, the number of spikes of each of the first to third input spike signals included in the first session data may be 0, 100, and 0. In this case, the number of spikes of each of the first to third input spike signals included in the second session data may be 1, 100, and 1.

In detail, when the correlation of random distribution characteristics between session data is high, rate distributions of the number of spikes input to input neurons included in each session data may be similar.

The spike interval of each of the first to m-th input spike signals ss11 to ss1m may have a random Poisson distribution. As in the above description, the spike interval of each of the first to m-th input spike signals ss21 to ss2m may have a random Poisson distribution.

The random distribution characteristic of the first to m-th input spike signals ss31 to ss3m included in the third session data has a high correlation with the random distribution characteristic of synaptic weights W12, W22, and W32 to Wm2 connected to the second output neuron ON_2.

The random distribution characteristic of the first to m-th input spike signals ss31 to ss3m may have a low correlation with the random distribution characteristic of the first to m-th input spike signals ss11 to ss1m or the random distribution characteristic of the first to m-th input spike signals ss21 to ss2m.

Accordingly, the spike neural network (SNN) 300 may determine whether the output spike is fired in each of the first output neuron and the third output neuron with respect to the first session data or the second session data. The spike neural network (SNN) 300 may determine whether the output spike is fired in the second output neuron with respect to the third session data.

When output spikes are fired in the first output neuron ON_1 and the third output neuron ON_3 with respect to at least some of the first to m-th input spike signals ss11 to ss1m included in the first session data, the spike neural network (SNN) 300 may train to increase the synaptic weights W11, W21, W31 to Wm1 connected to the first output neuron ON_1 and the synaptic weights W13, W23, and W33 to Wm3 connected to the third output neuron ON_3 to a first value. The synaptic weights connected to other output neurons may not be updated.

In this case, the membrane potential value of each of the plurality of output neurons ON_1 to ON_n may be initialized to 0.

After the output spikes are fired in the first output neuron ON_1 and the third output neuron ON_3, with respect to the remaining input spikes included in the first session data input to the first output neuron ON_1 and the third output neuron ON_3, the values of the synaptic weights W11, W21, W31 to Wm1 connected to the first output neuron ON_1 and the values of the synaptic weights W13, W23, W33 to Wm3 connected to the third output neuron ON_3 are reduced or maintained.

When the output spikes are fired in the first output neuron ON_1 and the third output neuron ON_3 with respect to at least some of the first to m-th input spike signals ss21 to ss2m included in the second session data, the spike neural network (SNN) 300 may perform evolutionary learning on the first output neuron ON_1 and the third output neuron ON_3.

In more detail, the spike neural network (SNN) 300 may train to increase the synaptic weights W11, W21, and W31 to Wm1 connected to the first output neuron ON_1 and the synaptic weights W13, W23, W33 to Wm3 connected to the third output neuron ON_3 from a first value to a second value. The synaptic weights connected to other output neurons may not be updated.

When the output spikes are fired in the second output neuron ON_2 with respect to at least some of the first to m-th input spike signals ss31 to ss3m included in the third session data, the spike neural network (SNN) 300 may train to increase the synaptic weights W12, W22, and W32 to Wm2 connected to the second output neuron ON_2. The synaptic weights connected to other output neurons may not be updated. In this case, the membrane potential value of each of the plurality of output neurons ON_1 to ON_n may be initialized to 0.

In this way, when session data having a random distribution having a high correlation with the random distribution of the first session data or the second session data is input, the spike neural network (SNN) 300 may perform evolutionary learning on the first output neuron ON_1 and the third output neuron ON_3 based on whether the output spike is fired.

As in the above description, when session data having a random distribution having a high correlation with the random distribution of the third session data is input, the spike neural network (SNN) 300 may perform evolutionary learning on the second output neuron ON_2 based on whether the output spike is fired.

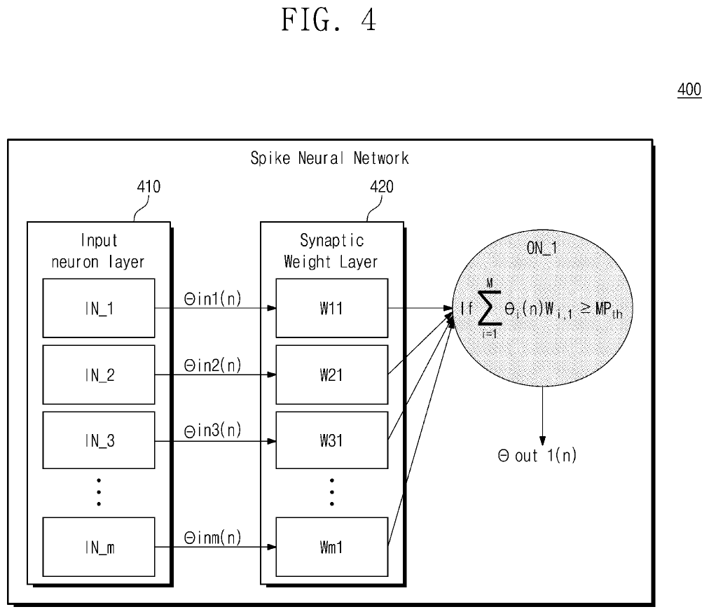

FIG. 4 is a diagram illustrating an embodiment in which a spike neural network (SNN) determines whether an output spike of a first output neuron fires. Illustratively, an input neuron layer 410 and a synaptic weight layer 420 included in a spike neural network (SNN) 400 of FIG. 4 correspond to the input neuron layer 110 and the synaptic weight layer 120 included in the spike neural network (SNN) 100 of FIG. 1, respectively. Therefore, additional descriptions of similar components and similar operations will be omitted to avoid redundancy.

Spike signals in1(n) to inm(n) included in the n-th session data output from an input neuron layer 410 of FIG. 4 correspond to the input spike signals ss1 to ssm received by the input neuron layer 310 of FIG. 3, respectively.

Illustratively, in FIG. 4, the random distribution characteristic of the spike signals in1(n) to inm(n) has a high correlation with the random distribution characteristic of the synaptic weights W11, W21, and W31 to Wm1 connected to the first output neuron ON_1.

Referring to FIGS. 1, 3, and 4, the synaptic weight layer 420 may perform a multiplication operation based on the spike signals in1(n) to inm(n) and the synaptic weights W11, W21, W31 to Wm1 connected to the first output neuron ON_1.

The first output neuron ON_1 may receive the multiplication operation result from the synaptic weight layer 420. The first output neuron ON_1 may fire the first output spike out1(n) with respect to n-th session data based on Equation 1 below. Here, Z1(n) may mean a membrane potential value of the first output neuron ON_1.

$${z}_{1} ( n ) = {\sum }_{i = 1}^{M} {θ}_{ini} ( n ) Wi 1 \qquad [ Equation 1 ]$$

When the membrane potential value (Z1(n)) of the first output neuron ON_1 is greater than a membrane potential threshold value MPth, the first output neuron ON_1 may fire a first output spike out1(n) based on Equation 2 below.

$${θ}_{out 1} ( n ) = \{ \begin{matrix}1 , & if : {z}_{1} ( n ) \geq {MP}_{th} \\ 0 , & else\end{matrix} \qquad [ Equation 2 ]$$

The spike neural network (SNN) 400 may train the synaptic weights W11, W21, W31 to Wm1 connected to the first output neuron ON_1 based on that the first output neuron ON_1 fires the first output spike out1(n). In this case, the synaptic weights W11, W21, W31 to Wm1 may be trained to increase their values.

Illustratively, FIG. 4 describes that the first output neuron ON_1 fires the first output spike out1(n). However, it is not limited thereto, and output spikes are fired in other output neurons ON_2 to ON_n based on the spike signals in1(n) to inm(n) output by the input neuron layer 410 whenever the session data is input.

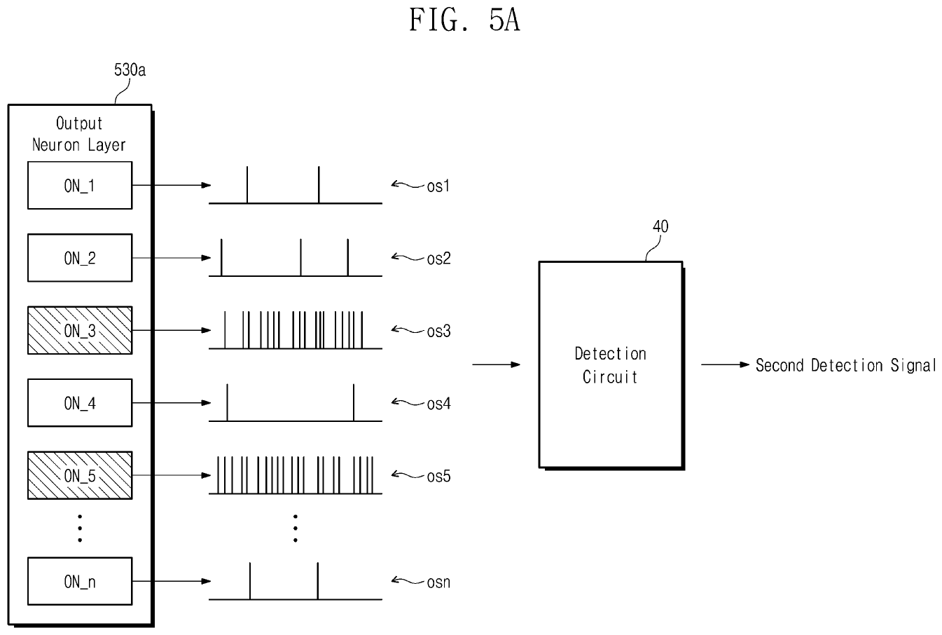

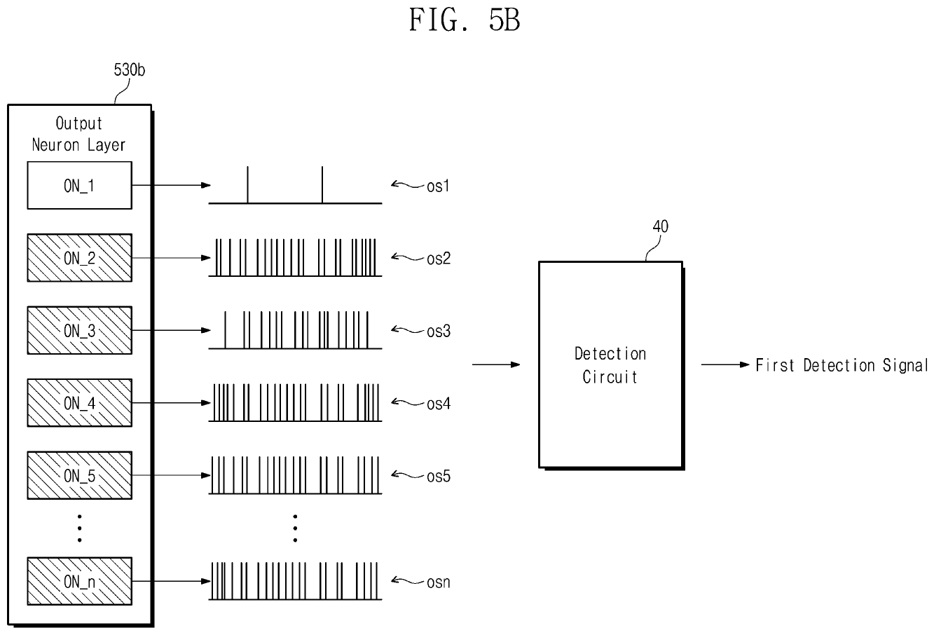

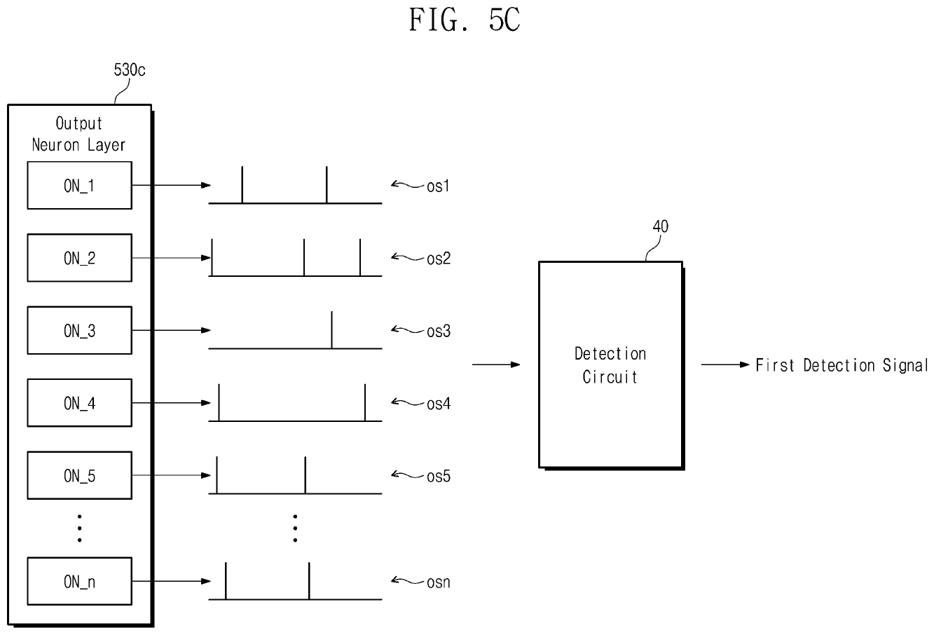

FIG. 5A is a diagram illustrating a first embodiment describing the number of output spike firings in each of output neurons. Illustratively, in FIG. 5A, an output neuron layer 530a may include the plurality of output neurons ON_1 to ON_n outputting a plurality of output spike signals os1 to osn with respect to, unlike data (first to n-th session data) input during the first time interval, the session data input during a second time interval after the first time interval.

The detection circuit 40 may compare the number of output spikes fired for each of the plurality of output spike signals os1 to osn with a first reference value. The detection circuit 40 may compare the number of output neurons firing output spikes equal to or greater than a reference value with a second reference value.

The detection circuit 40 may generate a detection signal based on a first comparison result of comparing the number of output spikes with a first reference value or a second comparison result of comparing the number of output neurons with a second reference value.

For example, the first reference value may be ‘10’ and the second reference value may be ‘5’. However, the first reference value and the second reference value are not limited thereto. Hereinafter, FIGS. 5A to 5C will be described based on that the first reference value is ‘10’ and the second reference value is ‘5’.

Referring to FIGS. 1, 3, and 5A, the random distribution characteristic of synaptic weights connected to each of the third output neuron ON_3 and the fifth output neuron ON_5 included in the output neuron layer 530a may have a high correlation with the random distribution characteristic of the session data input during the second time interval.

Alternatively, the random distribution characteristic of the k-th session data (e.g., ‘k’ is a natural number less than ‘n’) input during the first time interval in which the third output neuron ON_3 and the fifth output neuron ON_5 are trained may have a high correlation with the random distribution characteristic of the session data input during the second time interval.

Accordingly, the number of output spikes of the third output spike signal os3 and the fifth output spike signal os5 among the plurality of output spike signals os1 to osn may be greater than or equal to the first reference value. The number of output spikes of the remaining output spike signals may be less than the first reference value.

The detection circuit 40 may detect the third output neuron ON_3 and the fifth output neuron ON_5 that output the third output spike signal os3 and the fifth output spike signal os5, respectively.

The detection circuit 40 may generate a second detection signal based on the fact that the number of output neurons having the number of output spikes greater than or equal to the first reference value (e.g., the value of ‘2’) is less than or equal to the second reference value.

FIG. 5B is a diagram illustrating a second embodiment describing the number of output spike firings in each of the output neurons. Additional descriptions of components similar to those of FIG. 5A and operations similar to those of FIG. 5A will be omitted to avoid redundancy.

Referring to FIGS. 1, 3, and 5B, a plurality of output neurons ON_2 to ON_n included in an output neuron layer 530b may fire the output spike greater than or equal to a first reference value with respect to the session data input during the second time interval.

In this case, the session data may include input spike signals in which a large number of toggling occurs in a short time interval. Alternatively, the session data may include input spike signals overlapping synaptic weights connected to each of the plurality of output neurons ON_2 to ON_n.

The detection circuit 40 may detect the plurality of output neurons ON_2 to ON_n firing output spikes equal to or greater than the first reference value.

The detection circuit 40 may generate a first detection signal based on the fact that the number of output neurons (e.g., n-1) having the number of output spikes greater than or equal to the first reference value exceeds the second reference value.

FIG. 5C is a diagram illustrating a third embodiment describing the number of output spike firings in each of the output neurons. Additional descriptions of components similar to those of FIG. 5A and operations similar to those of FIG. 5A will be omitted to avoid redundancy.

Referring to FIGS. 1, 3, and 5c, session data having a low correlation with the random distribution characteristic of synaptic weights connected to each of the plurality of output neurons ON_1 to ON_n included in an output neuron layer 530c may be input during the second time interval.

Alternatively, session data having a low correlation with all of the first to n-th session data input during the first time interval may be input to the spike neural network (SNN) 100 or 300 during the second time interval. Alternatively, session data input during the second time interval may include input spike signals of which signal values are greatly reduced.

Accordingly, the number of output spikes of each of the plurality of output spike signals os1 to osn may be less than the first reference value. The detection circuit 40 may generate a first detection signal in response to detecting that there is no output neuron having an output spike number greater than or equal to the first reference value.

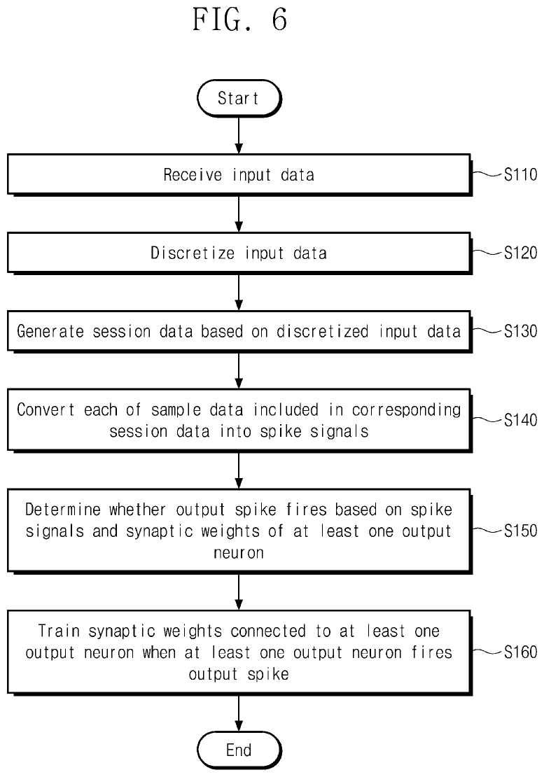

FIG. 6 is a flowchart illustrating an operation method of an anomaly data detection device during a first time interval, according to an embodiment of the present disclosure. Referring to FIGS. 1 to 6, in operation S110, the anomaly data detection device 1000 may receive input data.

In operation S120, the anomaly data detection device 1000 may generate discretized input data by discretizing analog input data.

In operation S130, the anomaly data detection device 1000 may generate session data based on the discretized input data. The session data may include first to m-th sample data generated as a result of sampling the discretized input data.

The anomaly data detection device 1000 may generate the first to m-th sample data whenever data is input during the first time interval. The data may include first to n-th session data.

In operation S140, the anomaly data detection device 1000 may convert the first to m-th sample data into first to m-th input spike signals with respect to each of the first to n-th session data.

In operation S150, the anomaly data detection device 1000 may determine whether the output spike of at least one output neuron fires based on the first to m-th input spike signals and the synaptic weights of at least one output neuron among the plurality of output neurons.

The anomaly data detection device 1000 may determine at least one output neuron based on a correlation between the random distribution characteristic of the first to m-th input spike signals and the random distribution characteristic of synaptic weights connected to each of the plurality of output neurons.

In operation S160, the anomaly data detection device 1000 may train synaptic weights connected to at least one output neuron when at least one output neuron fires the output spike. In this case, synaptic weights connected to at least one output neuron may be trained to increase their value.

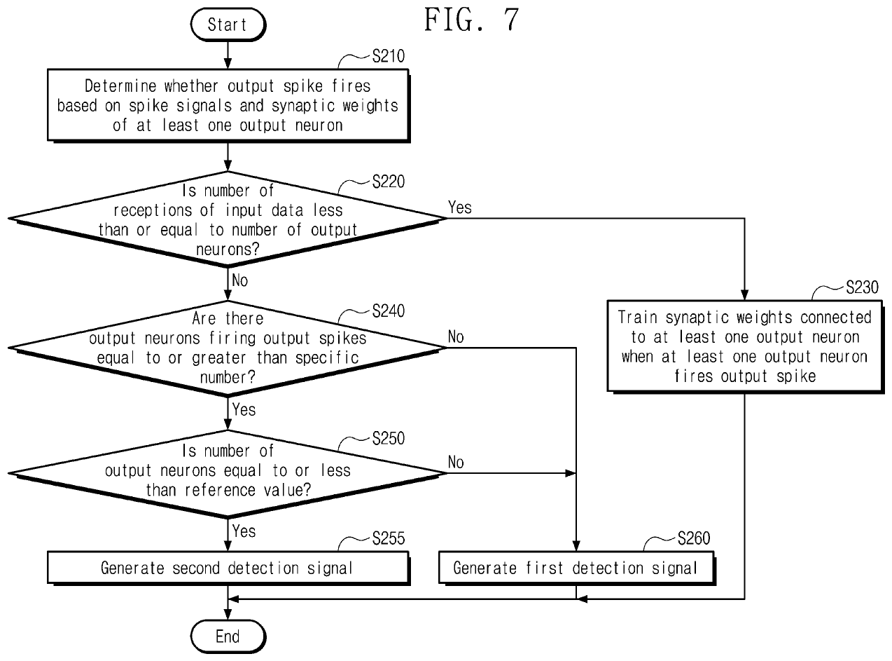

FIG. 7 is a flowchart illustrating an operation method of an anomaly data detection device during a second time interval after a first time interval, according to an embodiment of the present disclosure. Operation S210 in FIG. 7 may correspond to operation S150 in FIG. 6. Therefore, a detailed description thereof will be omitted to avoid redundancy.

Referring to FIGS. 1 to 7, in operation S220, when the number of receptions of input data is less than or equal to the number of output neurons, operation S230 may proceed. When the number of receptions of input data exceeds the number of output neurons, operation S240 may proceed.

Operation S230 in FIG. 7 may correspond to operation S160 in FIG. 6. For example, when the number of output neurons is ‘n’, the anomaly data detection device 1000 may train synaptic weights connected to at least one output neuron that fires the output spike while receiving first to n-th input data.

When the anomaly data detection device 1000 receives (n+1)-th input data during the second time interval, operations S240 to S260 may be performed.

In operation S240, the anomaly data detection device 1000 may detect whether output neurons firing output spikes equal to or greater than a first reference value exist. When the output neurons firing output spikes equal to or greater than the first reference value exist, operation S250 may proceed. When no output neurons firing the output spikes equal to or greater than the first reference value exist, operation S260 may proceed.

In operation S250, the anomaly data detection device 1000 may compare the number of output neurons firing output spikes greater than or equal to the first reference value with the second reference value. When the number of output neurons that fire output spikes equal to or greater than the first reference value is equal to or less than the second reference value, operation S255 may proceed. When the number of output neurons firing output spikes equal to or greater than the first reference value exceeds the second reference value, operation S260 may proceed.

In operation S255, the anomaly data detection device 1000 may generate a second detection signal. The second detection signal may include information detected that session data input during the second time interval is normal.

In operation S260, the anomaly data detection device 1000 may generate a first detection signal. The first detection signal may include information detected that session data input during the second time interval is anomaly.

According to an embodiment of the present disclosure, an anomaly data detection device and an operation method thereof may perform evolutionary learning on specific output neurons based on input data continuously input while changing within a normal range. In addition, according to an embodiment of the present disclosure, the anomaly data detection device may operate with low power by applying a spike neural network (SNN) capable of using spike signals.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An anomaly data detection device comprising:
a sampler configured to generate session data including first to m-th sample data based on input data input during a first time interval;
a spike signal generator configured to generate first to m-th spike signals respectively corresponding to the first to m-th sample data based on the session data;
a spike neural network configured to detect whether an output spike fires in at least one output neuron from among a plurality of output neurons based on the first to m-th spike signals and synaptic weights of each of the plurality of output neurons; and
a detection circuit configured to generate a detection signal based on the number of output neurons firing the output spike, and
wherein each of the first to m-th spike signals is generated by converting feature information of the corresponding first to m-th sample data into a spike rate code.

2. The anomaly data detection device of claim 1, wherein the feature information includes a size value and a change value of each of the first to m-th sample data.

3. The anomaly data detection device of claim 1, wherein the spike neural network determines the at least one output neuron to detect whether the output spike fires based on a first correlation between a random distribution of the first to m-th spike signals and a random distribution of the synaptic weights connected to each of the plurality of output neurons.

4. The anomaly data detection device of claim 1, wherein the spike neural network performs a first operation on the synaptic weights connected to the at least one output neuron and the first to m-th spike signals,
wherein the spike neural network performs a second operation on a result of the first operation and the at least one output neuron, and
wherein the spike neural network detects whether the output spike is fired in the at least one output neuron when a result of the second operation exceeds a threshold value.

5. The anomaly data detection device of claim 4, wherein the spike neural network increases the synaptic weights connected to the at least one output neuron when the output spike is fired in the at least one output neuron.

6. The anomaly data detection device of claim 4, wherein the output neurons include the at least one output neuron and remaining output neurons, and
wherein, when the output spike is fired in the at least one output neuron, the spike neural network maintains synaptic weights connected to each of the remaining output neurons.

7. The anomaly data detection device of claim 1, wherein the sampler generates first session data based on first input data input during the first time interval, and generates second session data based on second input data input during the first time interval, and
wherein the spike neural network detects whether the output spike fires in at least one first output neuron with respect to the first session data or the second session data based on a second correlation between the first session data and the second session data.

8. The anomaly data detection device of claim 7, wherein, when the output spike is fired in the at least one first output neuron based on the first session data, the spike neural network increases synaptic weights connected to the at least one first output neuron to a first value, and
wherein, when the output spike is fired in the at least one first output neuron based on the second session data, the spike neural network updates the synaptic weights connected to the at least one first output neuron from the first value to a second value.

9. The anomaly data detection device of claim 8, wherein the sampler generates third session data based on third input data input during the first time interval,
wherein, the spike neural network detects whether the output spike fires in at least one second output neuron with respect to the third session data based on a third correlation between the first session data or the second session data and the third session data, and
wherein, when the output spike is fired in the at least one second output neuron based on the third session data, the spike neural network increases synaptic weights connected to the at least one second output neuron and maintains synaptic weights connected to the at least one first output neuron.

10. The anomaly data detection device of claim 1, wherein the sampler generates fourth session data based on fourth input data input during a second time interval after the first time interval,
wherein the spike neural network detects whether the output spike is fired in the at least one output neuron with respect to the fourth session data, and
wherein the detection circuit generates a first detection signal based on an absence of an output neuron firing the output spike above a first value.

11. The anomaly data detection device of claim 10, wherein the detection circuit compares the number of the output neurons with a second value based on a presence of the output neuron firing the output spike above the first value, and
wherein the detection circuit generates the first detection signal based on that the number of the output neurons exceeds the second value.

12. The anomaly data detection device of claim 11, wherein the detection circuit generates a second detection signal based on that the number of the output neurons is less than or equal to the second value.

13. A method of operating an anomaly data detection device including a sampler, a spike signal generator, a spike neural network, and a detection circuit, the method comprising:
generating, by the sampler, session data including first to m-th sample data based on input data input during a first time interval;
generating, by the spike signal generator, first to m-th spike signals respectively corresponding to the first to m-th sample data based on the session data;
detecting, by the spike neural network, whether an output spike fires in at least one output neuron from among a plurality of output neurons based on the first to m-th spike signals and synaptic weights of each of the plurality of output neurons; and
generating, by the detection circuit, a detection signal based on the number of output neurons firing the output spike, and
wherein each of the first to m-th spike signals is generated by converting feature information of the corresponding first to m-th sample data into a spike rate code.

14. The method of claim 13, wherein the detecting of whether the output spike fires includes determining the at least one output neuron to detect whether the output spike fires based on a first correlation between a random distribution of the first to m-th spike signals and a random distribution of the synaptic weights connected to each of the plurality of output neurons.

15. The method of claim 13, wherein the detecting of whether the output spike fires includes:
performing, by the spike neural network, a first operation on the synaptic weights connected to the at least one output neuron and the first to m-th spike signals;
performing, by the spike neural network, a second operation on a result of the first operation and the at least one output neuron; and
detecting, by the spike neural network, whether the output spike is fired in the at least one output neuron when a result of the second operation exceeds a threshold value.

16. The method of claim 15, wherein the spike neural network increases the synaptic weights connected to the at least one output neuron when the output spike is fired in the at least one output neuron.

17. The method of claim 15, wherein the output neurons include the at least one output neuron and remaining output neurons, and
wherein, when the output spike is fired in the at least one output neuron, the spike neural network maintains synaptic weights connected to each of the remaining output neurons.

18. The method of claim 13, further comprising:
generating, by the sampler, second session data based on second input data input during a second time interval after the first time interval; and
detecting, by the spike neural network, whether the output spike is fired in the at least one output neuron with respect to the second session data, and
wherein the generating of the detection signal includes:
generating, by the detection circuit, a first detection signal based on an absence of an output neuron firing the output spike above a first value.

19. The method of claim 18, wherein the generating of the detection signal further includes:
comparing, by the detection circuit, the number of the output neurons with a second value based on a presence of the output neuron firing the output spike above the first value; and
generating, by the detection circuit, the first detection signal based on that the number of the output neurons exceeds the second value.

20. The method of claim 19, wherein the generating of the detection signal further includes:
generating, by the detection circuit, a second detection signal based on that the number of the output neurons is less than or equal to the second value.
